(19) United States
(12) Patent Application Publication
(10) Pub. No.: US 2010/0274409 A1
(43) Pub. Date: Oct. 28, 2010

(54) Stairlifts

(75) Inventors: Leonard Smith, Hampshire (GB); Tony Eric Palmer, Hampshire (GB)

Correspondence Address: NIXON & VANDERHYE, PC, 901 NORTH GLEBE ROAD, 11TH FLOOR, ARLINGTON, VA, 22203, US

(73) Assignee: STANNAH STAIRLIFTS LIMITED, Hampshire (GB)

(21) Appl. No.: 12/385,919

(22) Filed: Apr. 23, 2009

(51) Int. Cl. B66B 9/08; G05D 13/62

(52) U.S. Cl. 700/304; 187/201

(57) ABSTRACT

The invention describes an over-speed governor for a stairlift which not only triggers a safety gear or brake upon the carriage exceeding a pre-determined speed, but also triggers the safety gear in the event the carriage unexpectedly reverses its direction. In a preferred embodiment, the over-speed governor also triggers the safety gear in the event the chair departs from the horizontal by more than a predetermined angle. The speed determining function is preferably electronic and the safety gear operates in both directions without adaptation. Other aspects are described including setting the trip speed as a function of carriage position on the rail.

### FIELD OF THE INVENTION

This invention relates to stairlifts and, in particular, to the control of the movement of a stairlift carriage along a stairlift rail.

### BACKGROUND OF THE INVENTION

The movement of a stairlift carriage along a stairlift rail must be carefully controlled. This is particularly so in the case of curved stairlifts. Not only must the speed of the carriage along the rail be controlled within pre-determined limits, but also care must be taken to ensure that, as the stairlift carriage traverses transition bends in the stairlift rail, the chairlift chair does not depart from the horizontal to a noticeable extent. In this context, a transition bend is a bend which links sections of rail at different angles to a horizontal plane.

By regulation, stairlifts must have some form of device which prevents the stairlift carriage going “over-speed”. This is typically provided in the form of a over-speed governor mounted within the carriage which, in the event the stairlift carriage exceeds a pre-determined speed, displaces under centrifugal force, and releases or activates a safety gear. The safety gear, in turn, engages the rail, and brakes the carriage from further movement.

Whilst these forms of over-speed governor have been in use for many years, they are not without their problems. Because of manufacturing tolerances, they can be unreliable, and trigger the operation of the safety gear at speeds below the intended trip speed. The consequences can be particularly inconvenient as some installations require a serviceman to be called out in order to release the safety gear and re-set the over-speed governor.

An alternative form of over-speed governor to the centrifugal type, is described in UK Patent Application 2,339,419. The governor described in this patent does not operate under the influence of centrifugal force but, rather, senses the carriage speed electronically. When an over-speed situation is sensed, a solenoid is de-energised. This, in turn, releases the safety gear which brings the carriage to a halt.

Whilst the electronic speed sensing feature described in UK Patent Application 2,339,419 addresses the triggering unreliability of conventional governors operating under centrifugal force, the particular form of device described in this patent presents other problems. Firstly, the operation of the device described in UK Patent Application 2,339,419 relies upon the safety gear release solenoid being kept in a static, energized, configuration at all times. When any mechanical or electromechanical component is kept in a set is position for long periods of time, it is susceptible to seizure. This is of particular concern in the case of a component forming part of a safety system, such as a stairlift over-speed governor. Further, if an occupier vacates the premises in which the stairlift is fitted, say by going on vacation, then a supply of power must be left on to ensure the over-speed governor does not trigger in the occupier's absence. As a matter of convenience, this is important because, in the event the governor is triggered, and for whatever reason, the governor described in UK Patent Application 2,339,419 will require the attendance of a serviceman to in order to be re-set.

As stated above, curved stairlifts require the provision of a levelling function to maintain the chair level, whatever the angle of the rail with respect to the horizontal. Traditionally this function has been provided by various forms of mechanical arrangement, which have been regarded as ‘fail-safe’. Now, however, there is an increasing trend amongst stairlift manufacturers to effect levelling using a separate, electronically controlled, chair levelling motor. The advent of electronically controlled chair levelling motors has brought with it, concerns about safety. Rightly or wrongly, there is a concern amongst some in the stairlift industry, that electrical or electronics-based systems are, inherently, not as safe as mechanical systems. In the particular case of motorized chair levelling, there is a concern about the possibility of the chair going off-level to a dangerous extent, in the event of main drive failure occurring, particularly main drive failure occurring whilst the carriage is traversing a transition bend in the rail.

Typically the stairlift carriage is slowed when passing over a transition bend. Thus, should a failure occur in the drive system whilst the carriage is traversing a transition bend, it will take a greater length of time for the carriage to build up to a speed sufficient to generate the centrifugal forces necessary to trigger the over-speed governor, than would be the case if the carriage were traversing a straight section of rail. The worst case would arise in the event of failure as the carriage is moving in an uphill direction, and through a transition bend.

When the carriage is traversing a transition bend, the chair levelling motor is operating, under careful electronic control. The programming of the levelling motor control is established, on the basis of an expected carriage speed, so as to maintain the chair level within carefully defined parameters. Should the carriage drive suddenly fail in this instance, and the carriage speed suddenly increase, it is unlikely that the levelling function could react sufficiently quickly, before the carriage was halted by the over-speed governor, to ensure the chair level remained within acceptable limits. Furthermore, the chair levelling mechanism will have its own ‘over-angle’ sensor which, when the chair moves off level by more than say 5°, will cause power to the drive systems of the installation, including the chair levelling motor to be cut. If, at this time, the carriage is still in motion through a transition bend, the chair will be taken beyond this 5° limit as the carriage reverses out of the transition bend.

The problems outlined above are addressed in a substantial way by the form of over-speed governor and stairlift operating methodology described in our published International (PCT) Patent Application No. WO 2004/014773. However, proposed new regulations limiting the distance a stairlift can travel following a failure of the main drive, mean that the response times of all safety to features need to be enhanced still further.

It is an object of this invention to go at least some way in addressing the requirements and concerns expressed above; or which will at least provide a novel and useful choice.

### SUMMARY OF THE INVENTION

Accordingly, in one aspect, the invention provides a stairlift including a stairlift rail;

a carriage mounted for movement along said rail;

a chair mounted on said carriage,

speed sensing means operable to sense the speed of said carriage along said rail; and

braking means operable to brake said carriage with respect to said rail in response to said speed sensing means determining a tripping speed,

said stairlift being characterised in that:

direction determining means are provided to determine the direction of movement of said carriage, said direction determining means being capable of causing actuation of said braking means.

Preferably said stairlift further includes drive means to drive said carriage along said rail, said speed sensing means being independent of said drive means.

Preferably said speed sensing means is operable to sense, electronically, the speed of said carriage along said rail.

Preferably said speed sensing means includes a roller in rolling contact with said rail; and means to determine the speed of rotation of said roller.

Preferably said speed sensing means includes a plurality of magnets which rotate with said roller; and a sensor responsive to the passage of said magnets thereby, said sensor providing an output signal representative of the speed of rotation of said roller.

Alternatively said roller includes a plurality of radially extending fingers or vanes, said speed sensing means including a detection facility responsive to the passage of said fingers or vanes thereby and operable to generate an output signal representative of the speed of rotation of said roller.

Preferably said detection facility includes one or more Hall-Effect sensors.

Preferably said direction determining means is provided at least in part by said speed sensing means.

Preferably said speed sensing means includes a further sensor, said further sensor providing a further signal output representative of the speed of rotation of said roller, said further signal output being out of phase with said signal output, said direction determining means including a facility to compare the phase difference between said further signal output and said signal output.

Preferably said sensor and said further sensor comprise Hall-Effect sensors.

As a further alternative said roller may include, rotating therewith, a disc configured to allow a single detector to detect both speed and direction of rotation of said roller.

As an alternative said speed sensing means and said direction sensing means is provided by an electrical generator wherein the voltage output is representative of speed and the polarity is representative of direction; said stairlift further including means to monitor the polarity of said generator, and to cause actuation of said braking means in the event of unexpected changes in polarity.

Preferably said generator includes output terminals and wherein, in the event a tripping speed is detected or a change in polarity is detected, said terminals are short-circuited to lock said generator.

Alternatively, in the event a tripping speed is detected or a change in polarity is detected, said generator is positively driven to engage said braking means with said rail.

Preferably said chair is capable of pivotal movement as said carriage moves along said rail, said stairlift further including angle determining means operable to determine out of level positions of said chair, wherein said angle determining means being capable of causing actuation of said braking means.

In a second aspect the invention provides control means for a stairlift, said stairlift including:

a stairlift rail;

a carriage mounted on said rail for movement there-along;

a chair mounted on said carriage;

speed sensing means operable to sense the speed of said carriage along said rail;

braking means operable to brake said carriage with respect to said rail;

direction sensing means operable to sense the direction of movement of said carriage along said rail,

said control means including a microprocessor operable to receive signals from said speed sensing means and from said direction sensing means, and to generate a command to operate said braking means in response to said speed sensing means sensing a carriage speed at or in excess of a tripping speed, or said direction sensing means sensing an unexpected change in direction of movement of said carriage.

Preferably said control means is applied to a stairlift having a rail including rail sections at different angles to a horizontal plane; said chair being capable of pivotal movement as said carriage moves along said rail, to allow said chair to be maintained substantially level, wherein said control means further includes angle sensing means operable to sense positions of said chair at which the angle thereof with respect to said horizontal plane is at or in excess of a limit, said microprocessor being further operable to receive signals from said angle sensing means and to generate a command to operate said braking means in response to said angle sensing means sensing a chair angle in excess of a predetermined maximum.

Preferably said microprocessor is programmed to compare the sensed speed at various positions of said carriage along said rail with an expected speed for said carriage at corresponding positions of said carriage along said rail, the expected speeds being stored in memory; and wherein said microprocessor is programmed to generate a tripping command to said braking means should the sensed speed exceed the corresponding expected speed by a defined amount.

In a third aspect the invention provides a method of controlling a stairlift, said stairlift including:

is a stairlift rail;

a carriage mounted on said rail for movement there along;

a chair mounted on said carriage;

speed sensing means operable to sense the speed of said carriage along said rail;

braking means operable to brake said carriage with respect to said rail; and

direction sensing means operable to sense the direction of movement of said carriage along said rail,

said method including monitoring the speed of said carriage along said rail and monitoring the direction of travel of said carriage and, in the event either said speed exceeds a tripping speed or there is an unexpected change in the direction of movement of said carriage, causing said braking means to operate.

Preferably said method is applied to a stairlift having rail sections at different angles to a horizontal plane; a chair capable of pivotal movement as said carriage passes along said rail to allow said chair to be maintained substantially level; and angle sensing means operable to sense positions of said chair at which the angle thereof relative to said horizontal plane is at or in excess of a limit, said method further including monitoring said angle sensing means and, in the event said angle departs from said predetermined limit, causing said braking means to operate.

In a fourth aspect the invention provides a method of setting the trip speed of a over-speed braking device included in a stairlift, said stairlift having:

a rail;

a carriage mounted for movement along said rail;

an over-speed braking device operable, when tripped, to brake said carriage with respect to said rail,

said method being characterized in that it comprises varying the speed at which said over-speed braking device is tripped.

Preferably the tripping speed is established according to the position of said carriage along said rail.

Preferably expected speeds of said carriage at various positions of said carriage along said rail are stored in a memory, said method comprising comparing the speed measured at various positions of the carriage on said rail, with the corresponding expected speed, said tripping speed being established when the measured speed exceeds the expected speed by a predetermined amount.

Alternatively said method comprises measuring the speed of said carriage and establishing a tripping speed in the event of a defined increase in said speed in a defined time period.

Many variations in the way the present invention can be performed will present themselves to those skilled in the art. The description which follows is intended as an illustration only of one means of performing the invention and the lack of description of variants or equivalents should not be regarded as limiting. Wherever possible, a description of a specific element should be deemed to include any and all equivalents thereof whether in existence now or in the future.

### BRIEF DESCRIPTION OF THE DRAWINGS

The various aspects of the invention will now be described with reference to the accompanying drawings in which:

FIG. 1: shows a schematic view of a stairlift assembly incorporating the various aspects of the invention;

FIG. 2: shows a schematic logic diagram applicable to a control system in a stairlift according to the invention;

FIG. 3: shows an underside isometric view of an over-speed governor forming part of a stairlift assembly according to the invention;

FIG. 4: shows an end elevational view of the assembly shown in FIG. 3;

FIG. 5: shows a similar to FIG. 4 but, from the opposite side, omitting some parts for clarity, and showing an alternative speed sensing and braking facility;

FIG. 6: shows an isometric view of the over-speed governor assembly separated from the remainder of the stairlift carriage assembly;

FIG. 7: shows a plan view of the assembly shown in FIG. 6; and

FIG. 8: shows an exploded view of the components forming the assembly shown in FIG. 6.

### DESCRIPTION OF WORKING EMBODIMENT

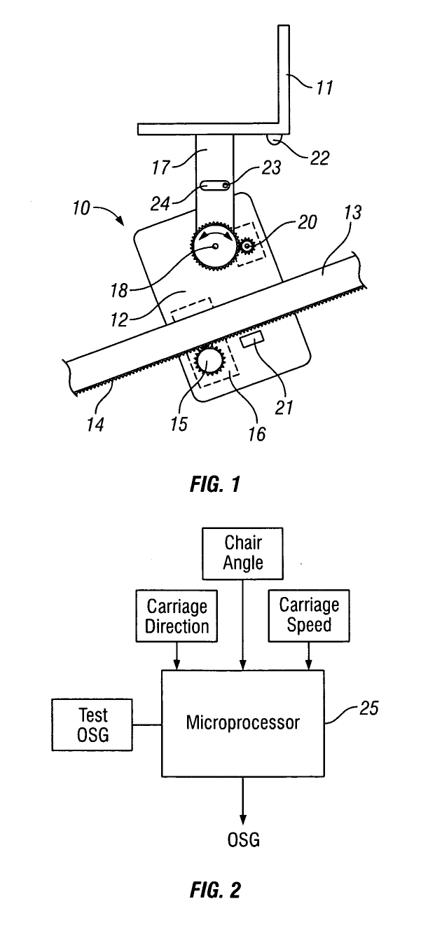

Referring firstly to FIG. 1, the present invention provides an over-speed braking facility or governor for a stairlift assembly 10. In the conventional manner, the stairlift assembly 10 includes a chair 11 mounted on carriage 12, the carriage 12 being supported on a number of rollers (not shown) for movement along a stairlift rail 13.

The carriage 12 is displaced up and down the rail 13 by suitable drive means. In the form shown, the drive means comprises a rack 14 mounted on the rail, the rack being engaged by a drive pinion 15 mounted on the output of carriage drive motor and gearbox 16, mounted in the carriage.

Aspects of the invention are applicable to both straight and curved stairlifts but the totality of benefits will be experienced in curved stairlifts and the description which follows relates to a curved stairlift.

Although not shown in the drawings the rail 13 includes a number of sections which are arranged at differing angles to a horizontal plane. For this reason the angle of the chair 11 must be capable of adjustment to ensure that, whatever the angle of the rail section with respect to the horizontal, the seat surface of the chair 11 can always be maintained substantially level. To this end, chair 11 is supported on an interface 17, which interface is pivotally mounted at 18 on the carriage 12. Level adjustment of the chair is conveniently effected substantially as described in our Patent 0 738 232. Thus, a chair levelling motor 20 is provided which, under electronic control, can pivot the interface 17 with respect to the carriage 12 as the stairlift moves through transition bends in the rail 13.

It will be appreciated that the inventive concepts described herein could also be applied to those embodiments in which the chair is fixed to the carriage and the combined chair and carriage assembly is pivoted, when the carriage moves through a transition bend in the rail, to maintain the chair substantially horizontal.

It thus follows that the precise method upon which chair levelling is effected does not form part of the present invention, although the invention is particularly suited to electronic based stairlift levelling systems, whether mapped electronic systems or sensor-based leveling systems.

As stated in the preamble above, stairlifts are required, by regulation, to have an over-speed braking facility or governor to brake the carriage to a halt on the rail in the event of a failure which causes the carriage speed to exceed a predetermined maximum limit This over-speed governor is indicated schematically by reference numeral 21 in FIG. 1 and broadly comprises a speed sensing part and a safety gear or brake, the latter being released or actuated upon the former sensing a tripping speed.

Additionally, and particularly in the case of stairlift installations having a separate chair levelling motor 20, means must be provided to ensure the chair 11 does not go off-level by more than a small margin, say 5°. To this end, angle determining means such as, for example, angle sensor 22 is provided on the underside of chair 11. The sensor 22 generates electronic output signals proportional to the tilt angle to either side of a vertical axis, and thus the outputs can be processed and used as triggers to cut power to the drive systems of the installation 10 when the chair angle limits are reached. As described in our European Patent 0 738 232, when the angular limit of the chair 11 is reached, a mechanical interlock such as pin 23 acting in slot 24 may also be triggered to prevent the chair 11 going further off-level.

It cannot, of course, be predicted when a drive system failure might occur leading in turn, to operation of the over-speed governor 21. There is a particular concern that the consequences will be more serious in the event failure occurs whilst the carriage 12 is negotiating a transition bend in the rail and, still more particularly, when the carriage is negotiating a transition bend while moving in an uphill direction.

It is common to slow the stairlift carriage as it negotiates bends in the rail. This is particularly so in those installations employing a separate, electronically controlled chair levelling motor 20. In such cases, the motion of motor 20 must be related, with precision, to the speed of carriage 12, not only to ensure that the chair remains within narrow limits around the horizontal at all times, but also to ensure that the rate of carriage speed and/or chair levelling does not cause alarm to the stairlift user.

Bearing in mind that the carriage is moving slower when negotiating a transition bend, it will therefore physically move further (compared with the case where the carriage is moving along a straight section of rail) before the speed becomes sufficient to generate the centrifugal forces necessary to trip the over-speed governor. Further, it is whilst the carriage 12 is negotiating transition bends, that the chair levelling motor 20 is in operation. If there were to be a sudden increase in carriage speed due to drive failure, the control system operating motor 20 simply could not react fast enough to prevent chair 11 going off-level by more than 5°, and possibly not rapidly enough to avoid a user being ejected from the chair. The problem is exacerbated by the fact that the safety systems built into the chair levelling system will, by then, have locked the chair to the carriage as the chair has gone off level by more than 5°.

In our published International Patent Application WO 2004/014773 we describe an over-speed braking facility in which the over-speed governor trips not just in response to the speed of carriage 12, but also in response to over limit positions of the chair 11. Whilst this represents a marked improvement over the prior art, we have established that safety can be enhanced still further, and response time improved, by adapting the over-speed braking facility to trip in response to unexpected changes of direction of movement of the carriage 12. This adaptation is preferably provided in addition to the chair angle response facility.

Referring to FIG. 2, signals which represent chair level, carriage speed and carriage direction are directed to a form of electronic intelligence, such as a microprocessor 25. The signals from the three inputs are processed within the microprocessor 25 and, in the event of pre-defined limits or events being sensed in any of the inputs (as described in greater detail below), a signal is directed to trigger the over-speed governor 21 and thereby lock the carriage 12 to the rail 13.

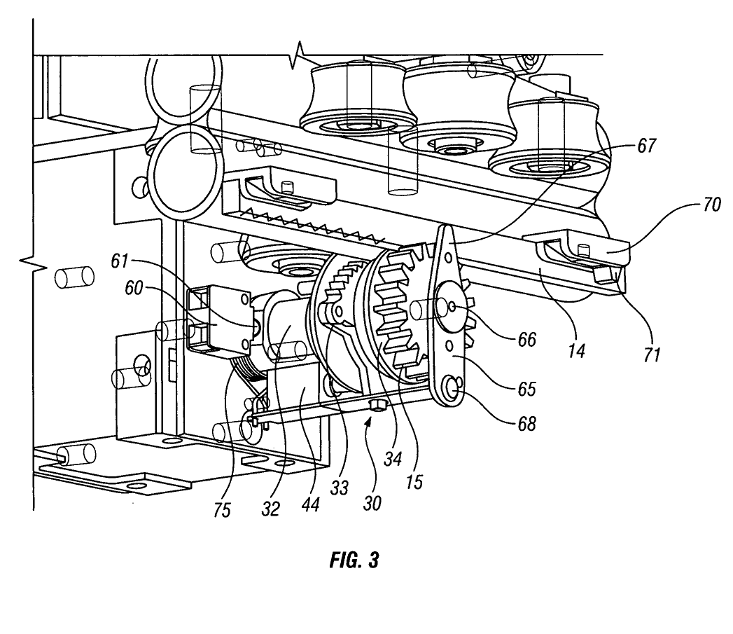

Turning now to FIG. 3 an over-speed governor assembly 30 is provided, mounted on the carriage 12, but so that the safety gear is able to engage the rail 13 to brake the carriage 12 against further movement on the rail. As can be seen, the over-speed governor 30 is mounted, concentrically with the drive pinion 15, about the main drive shaft 32 of the stairlift. However, as will be described in greater detail below, the over-speed governor assembly is mounted in such a manner that it can pivot about the drive shaft 32.

In the form shown, the safety gear comprises a cam member 33 which is mounted about the centre of bottom roller 34 in such a manner that bottom is roller 34 may rotate freely with respect to the cam 33. The cam 33 includes teeth 33a on the upper surfaces thereof which, when the speed sensor triggers the safety gear, engage the surface of rail 13. The arrangement is such that the cam 33 is equally effective no matter in which direction the carriage 12 is traveling.

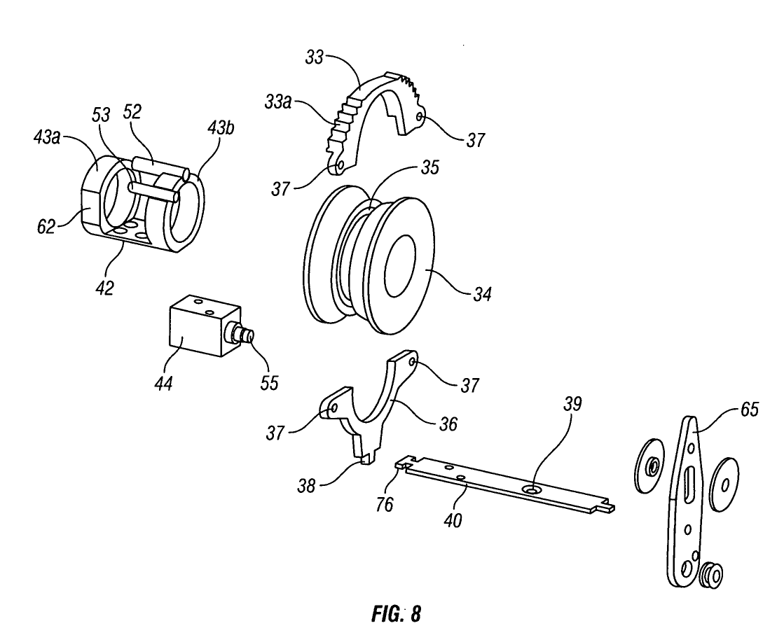

Referring now to FIG. 8, it can be seen that the cam member 33 is retained in central groove 35 extending about the bottom roller 34, by means of a yoke 36, the cam 33 and yoke 36 being fixed together by bolts or the like (not shown) passed through fixing apertures 37. At its lower end, the yoke 36 is provided with an extending tab 38 which engages in aperture 39 in a switch actuation plate 40.

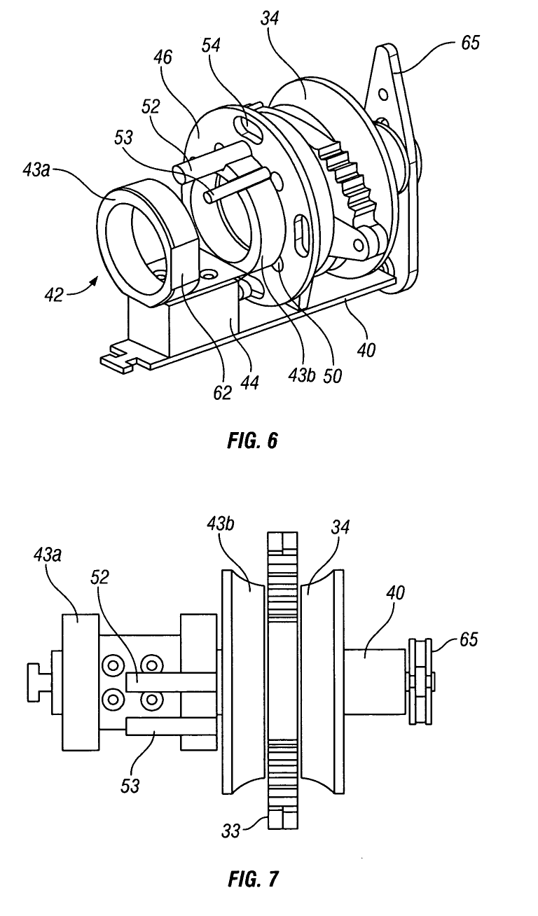

Referring to FIGS. 6 and 7, the over-speed governor assembly 30 further includes a cradle 42 having spaced aligned rings 43a and 43b which are sized to provide a sliding fit over drive shaft 32 and, in combination with bottom roller 34, support the assembly 30 on the drive shaft 32. Fixed to the underside of the cradle 42 is a solenoid 44. The switch actuation plate 40 is, in turn, fixed to the underside of the solenoid 44.

It will thus be appreciated that rings 43a and 43b, which support the cradle 42, allow the entire over-speed governor assembly to swivel, at least to some extent, about the drive shaft 32.

In the form shown the roller 34 is configured to be rotated by frictional engagement with the rail 13. It will be appreciated, however, that embodiments could be produced, falling within the various aspects of this invention, in which the roller 34, or a roller having equivalent functionality, was provided with a toothed outer surface, and positively driven.

Referring now to FIGS. 6 and 7, the rear surface 46 of bottom roller 34 has mounted therein, a series of permanent magnets 50. Mounted on cradle ring 43b, adjacent the bottom roller 34, is a magnetically responsive proximity sensor 52. This proximity sensor 52 is positioned on the same arc as is created when the permanent magnets 50 rotate with the bottom roller 34. Thus, as is well known, when each magnet 50 passes proximity sensor 52, a pulse wave is created, the time lapse between successive pulses giving a direct indication of the speed of rotation of the bottom roller 34.

The sensor 52 may, for example, be a reed switch. The magnets may be mounted so that the poles facing the sensor alternate north and south and thus ensure the sensor is positively switch each time a magnet passes thereby.

As one alternative, the sensor 52 may be a Hall-Effect sensor.

The output signal from the sensor 52 is advantageously monitored by microprocessor 25 and processed into an indication of carriage speed.

It will be appreciated that the number of magnets 50 and the type of sensor 52 establish the ability of the microprocessor to determine speed and, perhaps more importantly, to determine speed variation. By way of example only, we have found that using a roller having between 12 and 24 magnets thereon, in combination with a reed switch sensor 52, provides an adequate degree of sensitivity.

As an alternative to using magnets shown on the roller 34, a non-magnetic metal plate having radial fingers could be mounted on the rear surface 46 of the roller. A back biased Hall-effect sensor (one positioned between the plate and a fixed magnetic field) could then be used to create the pulse wave and achieve the same result.

We have also found that, by establishing a tripping speed for the over-speed governor 30 by electronic means as described, we give rise to an additional benefit in that we can vary that speed. More importantly, we can vary the tripping speed for different positions of the carriage on the rail. Thus, when the carriage is moving more slowly through a transition bend, we can set the tripping speed lower. This allows the safety mechanisms of the stairlift to respond far more quickly in the event of failure, and enhances user safety.

One way in which a variable tripping speed can be established is by reference to speed data stored in an electronic memory. In substantially the same manner as is described in our European Patent 0 738 232, expected speeds at various positions of the carriage on the rail, are stored in an electronic memory included within, or in communication with, microprocessor 25. In real time, as the carriage moves along the rail, speed readings are calculated as above described, and compared with the corresponding expected speeds stored in memory. If the measured speed exceeds the expected speed by a pre-determined factor (say, for example, 15% to 20%), an over-speed or tripping speed is deemed to exist and a command is generated to trigger the over-speed governor 30.

An alternative to storing expected speed data in memory is to calculate excessive speed ‘on the fly’. For example, if the set speed for the carriage increases by a predetermined mount within a predetermined period, an over-speed or tripping speed is deemed to exist and a command is generated to trigger the over-speed governor 30.

Whatever the methodology and means for determining an over-speed state, once that state is determined, the safety gear or brake must be moved into contact with the rail in the least possible time. To this end, included in the rear surface 46 of roller 34 are a number of lock slots 54. These slots 54 are positioned at such a radius from the centre of rotation of the roller 34 that they may, in use, receive the pin 55 of solenoid 44. Thus, when solenoid 44 is de-activated upon a tripping command being generated by microprocessor 25, pin 55 is mechanically displaced by a guided compression spring (not shown) included within solenoid 44, and engages in one of the slots 54. Should the roller 34 be rotating when the pin 55 extends, the entire over-speed and safety gear assembly 30 will be rotated in its cradle 42, about drive shaft 32, thus bringing cam surfaces 33a into engagement with the outer surface of rail 13.

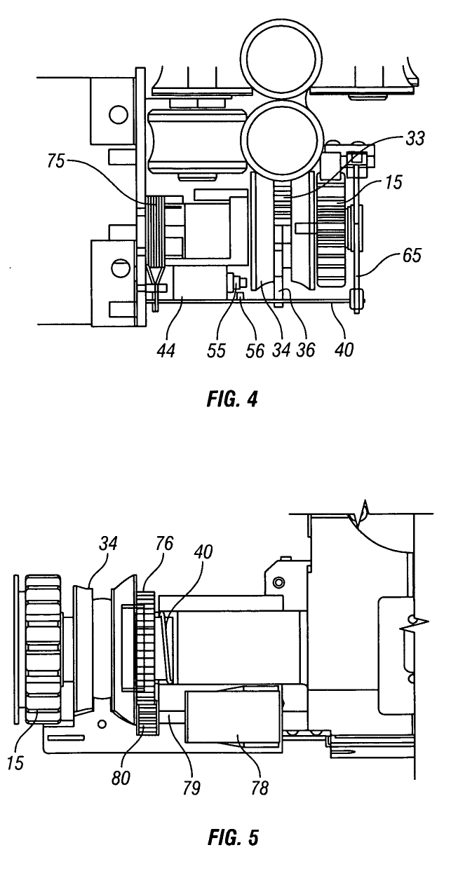

As shown in FIG. 4, a further sensor 56, which may be an optical electrical sensor of some suitable form, is preferably provided to sense if the pin is in its extended or retracted position, and to provide the appropriate status information to the microprocessor 25.

Again the configuration of the slots 54 will have a bearing on the response of the safety mechanisms herein described, the greater the number of slots the quicker a locking position will be established. Examples we have tested include up to 18 slots but the precise number does not form part of the invention and more slots or less could be used, if appropriate.

Also illustrated in FIG. 3 is an ultimate switch 60. This switch is called an ultimate switch because it acts as a breaker in the ultimate safety circuit of the stairlift installation.

As can be seen, the ultimate switch 60 is positioned on the carriage chassis such that its actuating pin 61 normally engages a flat surface part 62 formed on ring 43a of the cradle 42. If, however, the cradle 42 is rotated in either a clockwise or anti-clockwise direction about drive shaft 32, such as will happen when solenoid pin 55 locks into one of locking slots 54, the switch 60 will be actuated causing the power to be cut-off to the drive motor 16 and seat levelling motor 20.

The particular embodiment described herein combines features of the limit switches with the over-speed governor assembly. To this end, pivotally mounted at 66 on the outer end of drive shaft 32, is a trigger plate 65. The trigger plate 65 is tapered at its upper end 67 and is engaged at its lower end 68 with the switch actuation plate 40. The upper end 67 of the trigger plate is configured and positioned so as to engage charging/stop ramps 70 provided at each end of the stairlift rail 13. Each of the stop ramps 70 includes an ultimate limit 71 which, in the event of failure of the normal stopping facilities provided at each end of the rail, ensures the ultimate switch is triggered to bring the carriage to a halt. To this end, should the need arise, ultimate limit 71 engages end 67 of the trigger plate causing trigger plate to rotate about pivot 66. This, in turn, causes the switch actuation plate 40 to be displaced, so rotating the cradle 42 about drive shaft 32. When this occurs, the flat 62 on cradle 42 is moved out of its ‘neutral’ state so tripping switch 60 and causing power to be cut to the stairlift drive motor.

As described above, in one aspect the invention involves monitoring the direction of travel of the carriage 12, and responding in the event of an unexpected reversal of direction. The facility included in the stairlift to achieve this end is, in the embodiment shown in FIGS. 4, and 6 to 8, provided in part by the same facility which is used to sense carriage speed. More particularly, a further sensor 53 is provided which is positioned on the same arc as the sensor 52 and thus generates a further pulse wave as the magnets 50 pass thereby. The sensor 53 is preferably of the same form as the sensor 52 and is positioned and configured so that the pulse wave generated thereby is out of phase with the pulse wave generated by the sensor 52. Both pulse waves are fed to the microprocessor 25 which monitors the phase difference. By applying quadrature to the wave pulses one can determine if the carriage has reversed its direction. On such reversal being observed, the microprocessor is programmed to generate a command to trip the over-speed governor 30.

Referring now to FIG. 5, this drawing shows an alternative means of speed and direction sensing, as well as an alternative means of engaging the safety gear or brake. Although the safety gear or brake is not fully depicted in FIG. 3, it may be identical to that described above and shown in FIG. 8.

In FIG. 5 the magnets 50, the sensors 52 and 53, the slots 54 and solenoid 44 are all omitted. In place thereof a pinion 76 is fixed to the rear surface 46 of the roller 34 to rotate with the roller. Mounted on the switch actuation plate, in place of solenoid 44, is a small electric generator 78. The generator 78 has an input shaft 79 on which is mounted a drive pinion 80, the pinion 80 being in mesh with the pinion 76. Thus, as the roller 34 rotates, the generator 78 is rotated and an output voltage created. The size of the output voltage is directly proportional to the speed of rotation and can thus be processed by microprocessor to trigger the over-speed governor in the manner described above. Further, in the event of drive failure and the carriage moving in the reverse direction, the polarity of charge will reverse and the microprocessor can be programmed to detect this. The microprocessor can also be programmed to, in this eventuality, short-circuit the generator terminals thus causing the generator to lock solid. With the roller 34 rotating this, in turn, will cause the cradle 42 to pivot in the manner described above, the cam surfaces 33a to be drawn into contact with the rail, and the ultimate switch 60 to be operated.

As a variation of this alternative, instead of short-circuiting the output terminals of the generator in the event of an over-speed or reversal of direction, the microprocessor could configure the generator 78 as a motor to positively drive the cam surfaces 33a into contact with the rail.

Finally, it will be noted from FIGS. 3 and 4 that a torsion spring 75 is mounted about drive shaft 32 between the over-speed governor assembly and the chassis of the carriage. This coil spring is engaged with inner end 74 of the switch actuation plate and serves to maintain the over-speed governor assembly 30, and the trigger plate 65, in a central position during normal operation.

It will be appreciated by those skilled in the art that numerous other variations or modifications could be made to the apparatus described above, without departing from the scope of this invention. By way of example only, sensing direction change using a sensor based system as shown in FIGS. 3, 4 6 & 7 need not necessarily involve the use of two sensors. A shaped plate having non-symmetrical lobes could be used in conjunction with a sensitive sensor such that the sensor can distinguish different parts of the plate and, there-from, deduce the direction of rotation. An example of such an arrangement is the lobe sensing (bidirectional) application of the MLX90217 Hall-Effect cam sensor offered by Melexis (www.melexis.com). Further, the system described herein could be used as an addition or back-up to a purely mechanical over-speed sensing and braking device.

The operation of the apparatus above described is as follows: In the normal operating condition, the over-speed governor assembly 30 and trigger plate 65 are in the normal central position as illustrated in FIG. 3. Should over-speed or triggering speed of the carriage be detected, a signal will be sent to solenoid 44, de-activating the solenoid. Upon deactivation of the solenoid 44, solenoid pin 55 is displaced mechanically to engage in one of the locking slots 54 or, alternatively, the generator 78 will be locked. Whichever the case, the rotating roller will draw the cam surfaces 33a of the can plate 33 into engagement with the surface of rail 13, braking the carriage 12 to a halt. At the same time, the rotation of the assembly 30, including of the cradle 42, causes the isolation switch 60 to be triggered cutting off power to the stairlift motor.

Simultaneously with the speed of bottom roller 32 being monitored, the angle of the chair is also being monitored by microprocessor 25, receiving input from the level sensors 22, and movement of the carriage is monitored for unexpected reversal. Should the sensors 22 determine an “over-angle” state, or an unexpected reversal be detected, then once again the microprocessor 25 sends a signal to trigger the safety gear or brake, and isolation switch 60.

Independently of the over-speed function, or the chair angle monitoring function, or the carriage direction sensing function, isolation switch 60 can also be activated at each end of the stairlift's travel by engagement of trigger plate 65 with the end stops 70.

It will thus be appreciated that the present invention, at least in the case of the working embodiment described herein, provides for level control to be maintained and the carriage rapidly brought to a halt in the event of drive failure, particularly failure on transition and helical bends.

What is claimed is:

1. A stairlift including a stairlift rail;
a carriage mounted for movement along said rail;
a chair mounted on said carriage;
speed sensing means operable to sense the speed of said carriage along said rail; and
braking means operable to brake said carriage with respect to said rail in response to said speed sensing means determining a tripping speed,
wherein direction determining means are provided to determine the direction of movement of said carriage, said direction determining means being capable of causing actuation of said braking means.

2. A stairlift as claimed in claim 1 further including drive means to drive said carriage along said rail, said speed sensing means being independent of said drive means.

3. A stairlift as claimed in claim 1 wherein said speed sensing means is operable to sense, electronically, the speed of said carriage along said rail.

4. A stairlift as claimed in claim 3 wherein said speed sensing means includes a roller in rolling contact with said rail; and means to determine the speed of rotation of said roller.

5. A stairlift as claimed in claim 4 wherein said speed sensing means includes a plurality of magnets which rotate with said roller; and a sensor responsive to the passage of said magnets thereby, said sensor providing an output signal representative of the speed of rotation of said roller.

6. A stairlift as claimed in claim 4 wherein said roller includes a plurality of radially extending fingers or vanes, said speed sensing means including a detection facility responsive to the passage of said fingers or vanes thereby and operable to generate an output signal representative of the speed of rotation of said roller.

7. A stairlift as claimed in claim 6 wherein said speed sensing means includes one or more Hall-Effect sensors.

8. A stairlift as claimed in claim 1 wherein said direction determining means is provided at least in part by said speed sensing means.

9. A stairlift as claimed in claim 8 wherein said speed sensing means includes a further sensor, said further sensor providing a further signal output representative of the speed of rotation of said roller, said further signal output being out of phase with said signal output, said direction determining means including a facility to compare the phase difference between said further signal output and said signal output.

10. A stairlift as claimed in claim 9 wherein said sensor and said further sensor comprise Hall-Effect sensors.

11. A stairlift as claimed in claim 1 wherein said speed determining means and said direction sensing means is provided by an electrical generator wherein the voltage output is representative of speed and the polarity is representative of direction; said stairlift further including means to monitor the polarity of said generator, and to cause actuation of said braking means in the event of unexpected changes in polarity.

12. A stairlift as claimed in claim 11 wherein said generator includes output terminals and wherein, in the event a tripping speed is detected or a change in polarity is detected, said terminals are short-circuited to lock said generator.

13. A stairlift as claimed in claim 11 wherein, in the event a tripping speed is detected or a change in polarity is detected, said generator is positively driven to engage said braking means with said rail.

14. A stairlift as claimed in claim 1 wherein said chair is capable of pivotal movement as said carriage moves along said rail, said stairlift further including angle determining means operable to determine out of level positions of said chair, said angle determining means being capable of causing actuation of said braking means.

15. Control means for a stairlift, said stairlift including:
a stairlift rail;
a carriage mounted on said rail for movement there along;
a chair mounted on said carriage;
speed sensing means operable to sense the speed of said carriage along said rail;
braking means operable to brake said carriage with respect to said rail; and
direction determining means operable to sense the direction of movement of said carriage along said rail,
said control means including a microprocessor operable to receive signals from said speed sensing means and from said direction determining means, and to generate a command to operate said braking means in response to said speed sensing means sensing a carriage speed at or in excess of a tripping speed, or said direction determining means sensing an unexpected change in direction of movement of said carriage.

16. Control means as claimed in claim 15 when applied to a stairlift having a rail including rail sections at different angles to a horizontal plane; said chair being capable of pivotal movement as said carriage moves along said rail, to allow said chair to be maintained substantially level, wherein said control means further includes angle sensing means operable to sense positions of said chair at which the angle thereof with respect to said horizontal plane is at or in excess of a limit, said microprocessor being firer operable to receive signals from said angle sensing means and to generate a command to operate said braking means in response to said angle sensing means sensing a chair angle in excess of a predetermined maximum.

17. Control means as claimed in claim 15 wherein said microprocessor is programmed to compare the sensed speed at various positions of said carriage along said rail with an expected speed for said carriage at corresponding positions of said carriage along said rail, the expected speeds being stored in memory; and wherein said microprocessor is programmed to generate a tripping command to said braking means should the sensed speed exceed the corresponding expected speed by a defined amount.

18. A method of controlling a stairlift, said stairlift including:
a stairlift rail;
a carriage mounted on said rail for movement there along;
a chair mounted on said carriage;
speed sensing means operable to sense the speed of said carriage along said rail;
braking means operable to brake said carriage with respect to said rail; and
direction determining means operable to determine the direction of movement of said carriage along said rail,
said method including monitoring the speed of said carriage along said rail and monitoring the direction of travel of said carriage and, in the event either said speed exceeds a tripping speed or there is an unexpected change in the direction of movement of said carriage, causing said braking means to operate.

19. A method as claimed in claim 18 when applied to a stairlift having rail sections at different angles to a horizontal plane; a chair capable of pivotal movement, as said carriage moves along said rail, to allow said chair to be maintained substantially level; and angle sensing means operable to sense positions of said chair at which the angle thereof relative to said horizontal plane is at or in excess of a limit, said method further including monitoring said angle sensing means and, in the event said angle departs from said predetermined limit, causing said braking means to operate.

20. A method of setting the trip speed of a over-speed braking device included in a stairlift, said stairlift having:
a rail;
a carriage mounted for movement along said rail;
an over-speed braking device operable, when tripped, to brake said carriage with respect to said rail,
wherein said method comprises varying the speed at which said over-speed braking device is tripped.

21. A method as claimed in claim 20 wherein the tripping speed is established according to the position of said carriage along said rail.

22. A method as claimed in claim 21 wherein expected speeds of said carriage at various positions of said carriage along said rail are stored in a memory, said method comprising comparing the speed measured at various positions of the carriage on said rail, with the corresponding expected speed, said tripping speed being established when the measured speed exceeds the expected speed by a predetermined amount.

23. A method as claimed in claim 20 comprising measuring the speed of said carriage and establishing a tripping speed in the event of a defined increase in said speed in a defined time period.
